(19) United States
(12) Patent Application Publication
(10) Pub. No.: US 2024/0005927 A1
(43) Pub. Date: Jan. 4, 2024

(54) METHODS AND SYSTEMS FOR AUDIO VOICE SERVICE IN AN EMBEDDED DEVICE

(71) Applicant: Native Voice, Inc., Boston, MA (US)

(72) Inventors: John R. Goscha, Denver, CO (US); Ming Zeng, Guangzhou City (CN); Jianlai Yuan, Guangzhou (CN); Glenn J. Kiladis, Andover, MA (US); Harrison Ailin Ungar, Great Barrington, MA (US); Andrew L. Nicholson, Erie, CO (US)

(21) Appl. No.: 18/369,549

(22) Filed: Sep. 18, 2023

Related U.S. Application Data
(63) Continuation of application No. 17/139,231, filed on Dec. 31, 2020.
(60) Provisional application No. 63/036,531, filed on Jun. 9, 2020.

(51) Int. Cl. G10L 15/32; G10L 15/22; G10L 15/16; G06N 3/08

(52) U.S. Cl. CPC G10L 15/32; G10L 15/22; G10L 15/16; G06N 3/08; G10L 15/30

(57) ABSTRACT

A method and system to facilitate the use of multiple voice services using a common voice interface on a hearable device, the common voice interface enabling multiple wake word detections to enable users to connect to and interact with a selected voice service.

### CLAIM TO PRIORITY

This patent application is a continuation of and claims priority to U.S. patent application Ser. No. 17/139,231 (NATV-0001-U01) entitled “METHODS AND SYSTEMS FOR AUDIO VOICE SERVICE IN AN EMBEDDED DEVICE”, filed on Dec. 31, 2020, which published on Dec. 9, 2021 as U.S. 2021/0383811 A1.

U.S. patent application Ser. No. 17/139,231 (NATV-0001-U01) claims benefit of priority to U.S. Provisional Patent Application Ser. No. 63/036,531 (NATV-0001-P01) entitled “METHODS AND SYSTEMS FOR AUDIO VOICE SERVICE IN AN EMBEDDED DEVICE”, filed on Jun. 9, 2020.

Each of the foregoing applications is incorporated herein by reference in its entirety.

### FIELD

The present disclosure relates generally to voice enabled devices, and more specifically to the use of multiple voice services in voice enabled devices.

### BACKGROUND

Voice enabled devices may be enabled to allow users to voice activate a voice service with a service-specific wake word. However, users are confined to the use of a single voice service. Therefore, there is a need to enable a device to monitor for multiple voice service wake words to activate an indicated voice service.

### SUMMARY

The present disclosure describes innovations that facilitate use of multiple voice services using a common voice interface. The common voice interface enables multiple wake word detections, as opposed to detecting a single voice service's wake word, so that users can be connected to and interact with a selected voice service of their choosing (e.g., where the voice service is hosted in the cloud or on a local device or application.

### BRIEF DESCRIPTION OF THE FIGURES

FIG. 1 depicts a functional diagram in an embodiment of an audio voice service.

FIG. 2 depicts a detailed functional diagram in an embodiment of an audio voice service.

FIG. 3 depicts a functional diagram in an embodiment of a mobile device application in an audio voice service.

FIG. 4 depicts a process flow diagram in an embodiment of an audio voice service.

FIG. 5 depicts a process flow diagram in an embodiment of an audio voice service.

FIG. 6 depicts a functional diagram in an embodiment of a device and audio voice service.

FIG. 7 depicts a functional and process flow in a non-transitory computer-readable medium in an embodiment of an audio voice service.

FIG. 8 depicts a functional diagram in an embodiment of a hearable device and audio voice service.

FIG. 9 depicts a functional and process flow in a non-transitory computer-readable medium in an embodiment of an audio voice service.

FIG. 10 depicts a functional diagram in an embodiment of a device and audio voice service.

FIG. 11 depicts a process flow diagram in an embodiment of an audio voice service.

FIG. 12 depicts a process flow diagram in an embodiment of an audio voice service.

FIG. 13 depicts a functional and process flow in a non-transitory computer-readable medium in an embodiment of an audio voice service.

FIG. 14 depicts a process flow diagram in an embodiment of an audio voice service.

FIG. 15 depicts a functional diagram in an embodiment of a device and audio voice service.

FIG. 16 depicts a process flow diagram in an embodiment of an audio voice service.

FIG. 17 depicts a functional and process flow in a non-transitory computer-readable medium in an embodiment of an audio voice service.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

The present disclosure describes innovations that facilitate use of multiple voice services using a common voice interface. The common voice interface enables multiple wake word detections, as opposed to detecting a single voice service's wake word, so that users can be connected to and interact with a selected voice service of their choosing (e.g., where the voice service is hosted in the cloud or on a local device or application (herein also referred to as an ‘app’)). Hereinafter the wording ‘wake word’ may be interchangeable with ‘trigger word’. The present disclosure describes voice services and the use of wake words to invoke particular voice services. Throughout the present disclosure reference will be made to multiple voice services such as referred to as a ‘voice service 1’ (e.g., associated with a brand, organization, government agency, and the like), a ‘voice service 2’ (e.g., associated with a different brand, organization, government agency, and the like), a ‘voice service 3’, and the like. Further, throughout the present disclosure reference will be made to multiple wake words that are spoken and invoke the particular voice services such as referred to as a spoken “wake word 1”, a spoken “wake word 2”, and the like, where for instance the wake word is selected based on a word or sound associated with the voice service that the wake word invokes. In a non-limiting example of a voice service and wake word associated with a brand word, a voice service may be for example Amazon Alexa™ which may use the wake word “hey Alexa™”. In another non-limiting example of a voice service and wake word associated with an organization, a voice service may be for example a charity organization which may use the wake word “charity” to invoke a voice service of the charity organization. In another non-limiting example of a voice service and wake word associated with a service or utility, a voice service may be for example a weather service which may use the wake word “weather” to invoke a voice service of the weather service. Although these are examples of private, non-profit organization, and services, one skilled in the art can appreciate that wake words may be utilized to invoke a voice service for a wide variety of companies, organizations, services, utilities, and the like.

Several implementation embodiments may be envisioned for the voice interface. For instance, a push-to-talk embodiment (also referred to as a triggered or activated listening mode), where a hearable device (e.g., a true wireless stereo (TWS) device or other device with hearing functionality (e.g., including a microphone)) provides an interface such as a button (e.g., software or physical) to manually enter a listening mode for activating one of several voice services that are available. In this implementation, the software may only be required to distinguish between wake words, rather than distinguish between potential wake words and noise (as in an always listening mode), e.g., noise is not a concern given the triggered or manually activated listening mode.

In another embodiment, the voice interface may be implemented using a semiconductor device such as implemented in a small chip or memory, which in turn may be placed in devices such as TWS headphones, earbuds or other “hearables”. The chip (or suitable memory) may contain a model trained to detect multiple wake words in parallel such as using a neural network during an active listening mode. The device, on detecting one of the multiple wake words, activates the appropriate voice service.

Other form factors may be used or included as part of a system that accepts voice input, including any device that includes a microphone or connection for audio input, e.g., car audio systems, smart speakers, smartphones, tablets, PCs, home and office audio systems, and the like.

The voice service may be a cloud voice service and the connection may be facilitated via a mobile application (mobile app), e.g., resident on a smartphone, tablet, smart speaker, or similar device connected to the hearable device. The hearable device and mobile app then facilitate audio exchange with the voice service. In embodiments, the hearable device may connect directly with a voice service in the cloud, e.g., through a hearable device with the ability to connect directly to the internet rather than using personal area network (PAN) communication with a local device.

The voice service itself may be hosted in the cloud, provided on a local device via an app, or a combination of the foregoing. For example, a cloud voice service may be accessed via audio input to a hearable device, followed by identification and activation of a local virtual assistant, using a smartphone app or embedded firmware. A hearable device with the voice interface may allow any hearable device manufacturer to easily add voice assistants to their products (e.g., headphones, earbuds, etc.) using the infrastructure, embedded software and unique multi-wake word front-end hardware.

Additionally, this architecture may provide for a voice service library, enabling major brands to have a direct connection to customers with their own custom wake word solution. The voice services from the voice service library may be downloaded and located together on any device, e.g., smartphone, smart speaker, etc. These voice services may be accessed via a front-end device, which continually listens for wake words or listens for wake words in a triggered mode, and thereafter intelligently activates the corresponding voice service. In embodiments, one or more voice services may be simultaneously active, all possible wake works may be active, and the like, such as to enable a trigger word to access a plurality of voice services.

In embodiments, voice utilities may be included as frequently utilized voice functions native to a device or device ecosystem. A voice utility is a frequent function the user may invoke using voice. The voice utility may be invoked with different wake words or one wake word associated with the voice utility. Examples include voice inputs such as “call”, “set a timer”, “call”, or “set a timer”. The voice input may be mapped to a predetermined function or set of functions of the voice utility. Voice utilities may include but are not limited to those found in the Utilities section as described herein.

In addition to interacting with a voice service, e.g., a cloud voice service, embodiments may permit a wake word and command combination to invoke other systems. For instance, a wake word followed by a command routes the command to any system or service (not only a voice service). By way of example, the wake word may open an app on a smartphone, with the command indicating that the app open a particular page or pre-load particular information.

Furthermore, because the common voice interface will provide users access to multiple voice services, it also provides user data (e.g., wake words used, products purchased, payment details, etc.). Users may be given direct control over this data and its use, including where it is stored and with whom it is shared. Current example uses for such data, if permissioned by users, include providing collection and use of profiling data based on users' interactions with voice services and the like.

In embodiments, a virtual wallet may be provided for users to facilitate payments made for purchases conducted using various voice services. The wallet may be accessed using voice input and used with partnered voice services.

Methods and systems are described herein where a single audio device makes more than one voice service available via wake word detection. Distinguishing between more than one wake word spoken by the user may be accomplished via a triggered listening mode (e.g., button push), via an always listening mode, and the like, which may be implemented using a hearable device such as a hearable device.

This would facilitate adoption of multiple voice services rather than driving users to choose between closed communities. This would further allow users to choose among several available voice services depending on the task to be accomplished, where certain voice services may excel in some areas but not others.

In embodiments, a hearable device may be used as an input device that is transitioned into an activated or triggered listening mode. This triggered mode is activated via user input, e.g., manual input such as a button press on a hearable device. The triggered listening mode enables capture of a small amount of audio, i.e., including a wake word. This also signals to a wireless communication platform that a signal should be sent to an app on a local device (e.g., smartphone app) to receive the captured audio for wake word detection, selection of an appropriate voice service, and activation of the voice service. For instance, the audio captured following activation is processed by a connected device such as a smartphone to identify the wake word, associate it with a voice service, and activate the voice service for use. In embodiments, a simplified model may be used on the hearable device to identify the wake word prior to sending the activation signal.

In embodiments, an ‘always listening’ mode may be provided in which the wake words are detected by the hearable device that carries a more sophisticated wake word detection model. Detection of multiple, simultaneous wake words in an always listening mode via a hearable device represents a challenge with typical voice recognition technology. However, with voice recognition has gradually integrated increasing levels of neural network machine learning models for aspects of recognition. For instance, the basic model of recognizers may involve two steps. First, feature extraction is performed and thereafter pattern matching is conducted using the extracted features. If pattern matching is performed independently for each wake word, then error rates multiply as independent events.

However, when performing recognition in parallel over the feature stream using a neural network, the pattern matching is not independent and therefore the error rates do not multiply. In this method, error rates across multiple wake words are a function of the investment in training the network model. In embodiments, neural net voice recognition hardware may be utilized, such utilizing deep learning and low power artificial intelligence processing.

In an example, a wake word engine may be capable of more than two wake words with acceptable error rates, updatable in the field (e.g., a wake word model may be updated with new models, such as with more wake words), low always listening power consumption, and the like.

For instance, a neural net voice recognition hardware device may use about 150 uA when in listening mode. This is low enough to be less than 5% of the total power budget for a typical earbud which is 10-20 mA while listening to music.

After wake word detection on audio input via a microphone, the hearable device communicates with a connected device (e.g., mobile phone) via a wireless platform.

Multi wake word detection functionality within a hearable device may act as a universal or common front-end voice interface device for accessing the voice service offerings of others. A front-end device that frees the user to interact with any voice service the user chooses via a standard wireless communication mechanism would enable a variety of voice services that are capable of being chosen by the user. These voice services may be co-located on devices such as smartphones, smart speakers, IoT devices, or even more broadly on any device with which a user may choose to interact via voice (e.g., car consoles, kiosks, and the like).

These voice services may also facilitate purchases, enabling embodiments to act as a payment or wallet application that not only activates a given voice service, but may facilitate a common payment scheme for making purchases via any of the chosen voice services. This may take the form of storing user data, including payment data, in a cloud or other storage location and making it accessible to voice services, mobile apps, or an intermediary (e.g., payment processor) acting in concert with a voice service.

As with purchases and handling payment data, the embodiments may facilitate a single sign on (SSO) service that permits users to access a commonly accepted credential or access a store of credentials for use of various voice services. This would facilitate not only activating a chosen voice service but allow the user to have meaningful interactions with the voice services. The sign on may be accomplished using a voice pin or a voice ID may utilize voice biometrics (voice print) to authenticate the user.

Additionally, because the front-end common voice interface technology acts as an introduction point (and potentially facilitates a payment mechanism), a large amount of useful user data may be accessible. This data may be used to profile users. This user data may be controlled by the users. Authorized uses of this data may be utilized to facilitate advertising to users based on expressed interests. Similar to other profiling or user data, a user may secure this data, for example stored in a cloud location, using a voice pin, predetermined keyword or voice print and control the access to the data and the uses of the data.

### System (Front-End, Mobile App, Voice Cloud)

As described herein, a hearable device facilitates multiple wake word detection and consequently multiple voice service usage. In one example, multiple wake words can be distinguished in a triggered listening mode, e.g., identified following a button press. In another example, multiple wake words can be distinguished in an always listening mode, e.g., via implementation of a trained model embedded into a hearable device.

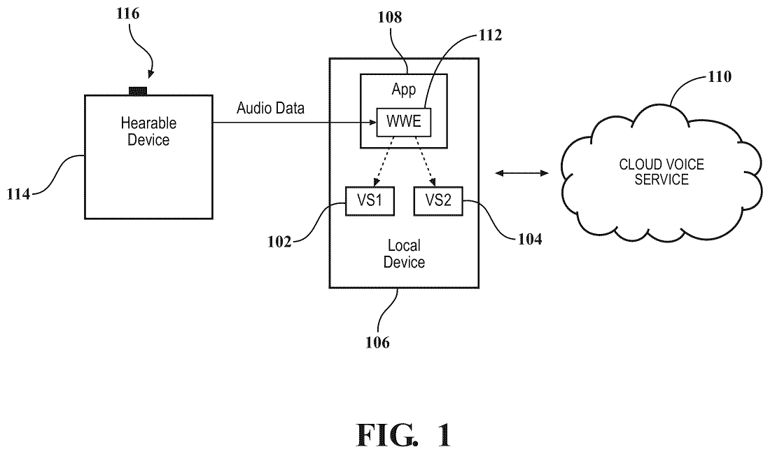

In embodiments, a hearable device is used as an input device that is transitioned into an activated or triggered listening mode. This triggered mode may is activated via user input, e.g., manual input such as a button press on a hearable device. The triggered listening mode enables capture of a small amount of audio, i.e., including a wake word. This also signals to a wireless communication platform of the hearable device that a signal should be sent to an app on a local device (e.g., smartphone app) to receive the captured audio for wake word detection, selection of an appropriate voice service, and activation of the voice service. The smartphone app may include functionality to distinguish between one of two or more wake words in a wake word engine (WWE). The wake words to be detected may be determined by the voice services (e.g., voice service 1 (VS1), voice service 2 (VS2), and the like) on the smartphone and are used to associate the identified wake word with a voice service, and activate the voice service for use. As shown in FIG. 1, the voice services VS1 102 and VS2 104 may be located on the local device 106 (e.g., a smartphone or other computing device) or these may be apps 108 that provide access to a cloud voice service 110 (Cloud VS), or a combination of the foregoing. Likewise, it is also possible that a simplified WWE 112 (such as utilizing a WWE model) may be used on the hearable device 114 to identify the wake word prior to sending the activation signal to the local device. In embodiments, as described herein, a push-to-talk function 116 (e.g. button) may be used.

In embodiments, a modular addition to a customer's existing hearable device hardware design may be integration of a WWE having a model trained to identify wake words of more than one voice service. The trained model may be implemented in a modular chip or elsewhere, e.g., on the hearable device primary system on chip (SoC) or other memory location. In a non-limiting example, a chip in a TWS headphone, earbud, or hearable device may permit the device to identify multiple wake words and facilitate selection of the voice service the user has indicated via speech input.

In embodiments, the hardware connections in an earbud may utilize a hardware chip. It is again noted that some or all of the functionality of the WWE may be implemented using another device, such as a smartphone implementing a model to identify wake words captured during a push-to-talk scenario. In an example, a microphone is connected to the WWE over a suitable interface, e.g., a pulse density modulation (PDM) interface, and the WWE connects with a wireless communication platform over a suitable interface, e.g., SPI. A communication element or pin, e.g., general purpose input output (GPIO), is connected so the WWE can interrupt the wireless communication platform to wake it from sleep on detection of a wake word (or on capture of audio in a push-to-talk implementation).

The microphone of the hearable device can listen for wake words in an always-listening setting. This permits capture of audio for processing by the front-end and WWE, implemented in this example via the chip.

In an active listening mode example, the WWE contains a deep neural network model trained to identify multiple wake words in parallel. The wake words may be predetermined, selected by the user, and updated. For example, the neural network model may be trained for common wake words initially (a predetermined set) or a hybrid wake word set (e.g., common wake word followed by a set of voice service specific words for activation). A user may select a model trained for different wake words, e.g., indirectly via download of an additional or different voice service app to the user's phone (as described further herein). Also, the model may be updated, e.g., via app refresh, patch or user specific voice training. For example, updates may be sent when a new version of the model is released for download, e.g., to detect additional wake words or speech features such as pitch or tone (to indicate a type of speech, such as a question) or additional apps are made part of the voice services or added to the user's local device (again, further described herein).

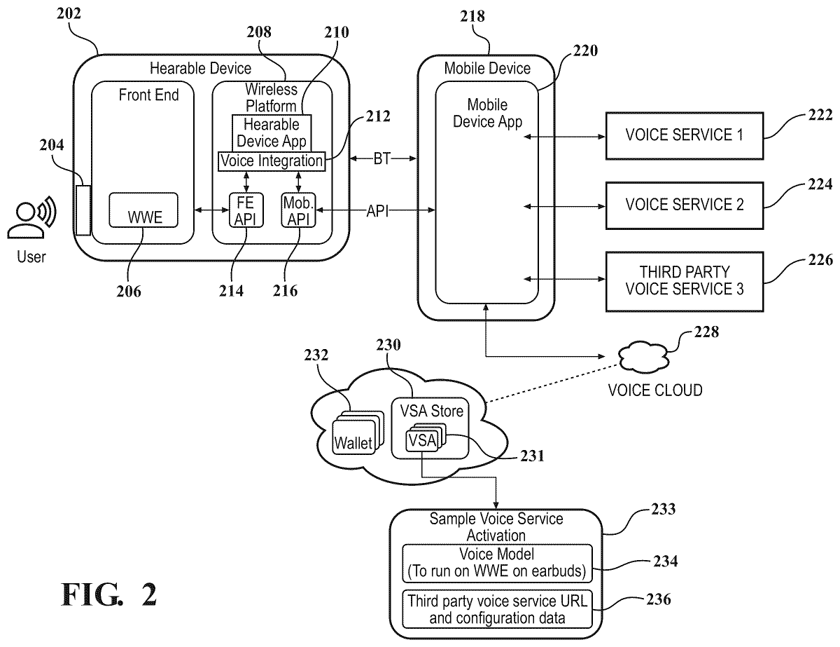

After a wake word is detected by the WWE, a communication mechanism is activated to ultimately activate a voice service (not shown in FIG. 1). This activation of the voice service may take the form of transmitting data (e.g., predetermined information for activation of a specific voice service) to a mobile app resident on a connected device (e.g., mobile phone). It is noted that as with a hearable device (or any front-end device), the connected device may take a wide variety of forms (e.g., “mobile device” is used in FIG. 2, although it need not be limited to mobile devices). A mobile phone or smart speaker are used here as non-limiting examples of devices connected to a hearable device housing the WWE.

An example system showing devices and applications or functions that may be involved in various processes is illustrated in FIG. 2. It may be possible to combine the system elements or functions or split them differently than what is illustrated, e.g., incorporate part or all of the front-end (WWE) and communication mechanism into a connected device (e.g., mobile device), or use alternative elements (e.g., wired communication, different connected devices). Likewise, various data described in connection with FIG. 1 and FIG. 2 may be suitably modified to accommodate other scenarios such as a push-to-talk use case or a case where some or all of the WWE is located on a device other than the hearable device. For example, a simplified WWE may be placed on the hearable device (e.g., that distinguishes between two or more wake words in a triggered listening mode).

With respect to the example of FIG. 2, on receiving via the microphone 204 on a hearable device 202 (e.g., a device in the form of a TWS earbud) a wake word input by the user, the front-end WWE 206 identifies the wake word and associates it with predetermined data, which is passed to the wireless communication platform 208, including for instance an application hearable device app 210 and voice integration 212, via the front-end API (FE API) 214, and on to a remote mobile device app 220 on a mobile device 218, via the mobile app API (Mob. API) 216.

Note that in the implementation shown in FIG. 2 the user's speech or audio data is not simply passed to the mobile device app 220 for detection of a wake word. Rather the wake word is first identified on the hearable device 202. The hearable device 202 may also select an appropriate voice service 222, 224, or 226, via communicating data indicating this selection to the mobile device app 220 to facilitate communication with the selected voice service. The activation of the voice service may be accomplished via the mobile device app 220, which in turn may directly communicate with the voice service via an API provided by the voice service (not shown). In a push-to-talk implementation, the hearable device 202 may simply pass the audio to a connected mobile device 218 for wake word identification and voice service activation. Likewise, in an implementation where the hearable device 202 may be enabled to communicate with a voice cloud service without an intermediary mobile device 218 (e.g., mobile phone), such as communicating via a telecom network, some or all of the functions attributed to the mobile device 218 in FIG. 2 or WWE 206 may be implemented using the hearable device 202, a cloud service, or a combination of the foregoing.

In the example of FIG. 2, the mobile device app 220 receives an indication of a selected voice service from the hearable device 202. This indication may take a variety of forms. For example, the indication may include predetermined data that is coded to indicate the detected wake word, the associated voice service, and the like. A feature for a hearable device 202 with an integrated WWE 206 is that the wake word is detected by the WWE 206 in the hearable device 202 and the WWE 206 is not limited to use of a single voice service wake word. That is, a user may speak a wake word to interact with a voice service to interact with a voice service (e.g., using a voice assistant) without the need to physically interface with the hearable device 202 or have it reprogrammed, e.g., via interaction with a partner mobile device application. In the implementation illustrated in FIG. 2, the behavior of the hearable device 202 in combination with the mobile device app 220 is akin to a smart speaker. The added functionality is that the hearable device 202 detects multiple voice assistant wake words and the hearable-mobile device system (202 and 218) therefore allows interaction with multiple voice clouds without configuration by the user. This makes the approach useful in a portable implementation, e.g., the hearable device (e.g., earbud) functionality illustrated in FIG. 2 may be provided on any device that users carry with them to facilitate voice interaction with any other device (e.g., smart speaker, car, etc.) offering access to voice services (local or implemented via the cloud) via a similar mobile app or another software layer.

Additionally, this permits the hearable-mobile device system (202 and 218) to be open to additional voice services. Voice apps, which may be implemented as part of the mobile app (such as using a software development kit), act as an interface or connection to cloud voice services. These voice apps may be contained within an offering (e.g., cloud voice APIs) or as stand-alone apps (e.g., third-party branded apps that are coupled to an integration layer on the mobile device that handles routing of wake word activation events). In any implementation, a function (software) may facilitate communication between the front-end and the voice app to provide an indication that a wake word has been detected and to facilitate audio delivery from the microphone to the appropriate voice service, which may reside in the cloud.

The mobile app or data allowing a third-party app/OS to function in an equivalent manner may be obtained (in whole or in part) from a variety of sources, e.g., downloaded to a mobile device or the hearable device. For example, a voice service library may offer access to downloads of mobile voice services for facilitating the functionality of the common voice interface. In the illustrated example or FIG. 2, the voice service library may include a voice service activation (VSA) store 230, which is a web-backed voice services store specifically for accessing VSAs 231. The VSA store 230 may be accessible through a mobile app (e.g., mobile device app 220). Essentially the VSA store 230 provides appropriate data (module of functional code or link thereto) for using the front end (e.g., in the hearable device) to activate a selected voice service, e.g., a voice service activation downloaded from the VSA store 230 may include wake word model extensions (provided to the WWE), a pointer or link to configuration data for the voice service, and additional service capabilities provided by the platform, e.g., wallet services 232. A VSA 231 may be a binary blob containing the information necessary to enable a hearable device with a WWE to access a cloud based third-party voice assistant service. The package may also include information to update the WWE model, configuration for the mobile device app or other intermediary, and other updates to the system as necessary. Therefore, the solution includes the ability to add support for new voice assistants and other services through the VSA store, e.g., accessed through a smartphone mobile device app or a 3rd party smartphone app containing the SDK. A VSA 231 may provide for voice service activation 233, such as including a voice model 234 (e.g., to run on the WWE of a hearable device (e.g., earbud)), third-party voice service URL and configuration data 236, and the like.

In embodiments, the mobile device app 220 may accept wake up word information from an enabled hearable device 202 and routes subsequent voice audio commands to the appropriate voice service 222, 224, or 226, e.g., via the voice assistant APIs 216. By way of example, the mobile device app may communicate directly to voice service 1 222 or voice service 2 224 depending on which voice service the end user has activated with the wake word. Alternatively, if parts of the mobile device app are located on a hearable device, communication with the activated voice service may be made directly without an intermediary device.

In embodiments, a software program, e.g., implemented by the mobile device, may further use contextual processing to make sure the wake word is intended. As described, the mobile application may present the user with access to the VSA store and may also manage voice assistant login credentials and handle updates to the enabled hearable device (e.g., such as new wake up word models and other related functions). The credentials may be authenticated using a voice pin or voice print. In one version of the mobile device app, an account for the user may be created, login credentials managed, and a facade of the VSA store presented. In another version of the mobile device app, the VSA store may allow downloadable support for voice clouds. The mobile device app may be configured as a software development kit for integration with a customer's existing hearable device app (e.g., third-party headphone app), such as including a white label version with sample code for use as a standalone app.

In an embodiment voice cloud, a data store may be provided for user identities. The voice cloud may also host the VSA store, apps, user wallets and other user data (such as profiling data, preference data, connection data (to voice services or other services), payment data, credential data, etc.). This data need not be limited to data directly or indirectly obtained from audio; however, other data may not be related to audio in some way, such as geolocation data gathered by the mobile app while a voice service is being used.

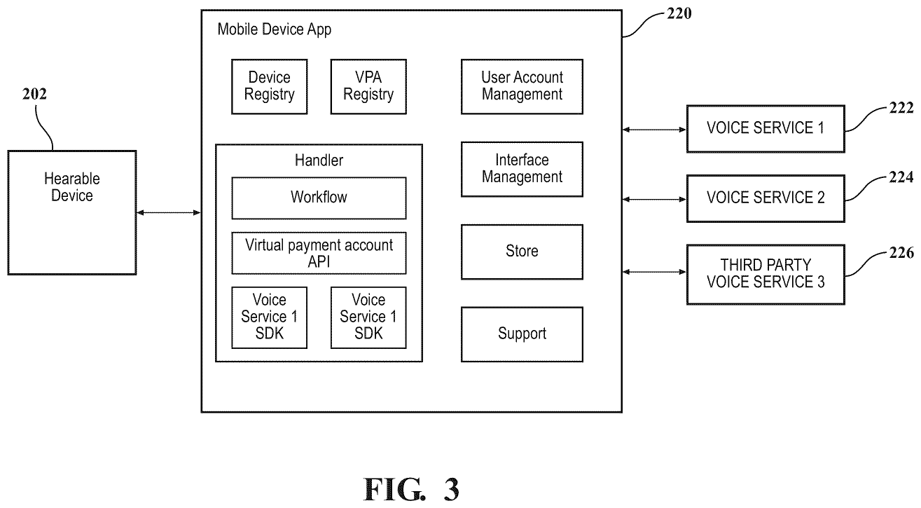

Referring to FIG. 3, a mobile and cloud architecture for supporting user identities in a cloud store is provided, including the hearable device 202 interfacing with the mobile device app 220 as communicatively connected to voice services 222, 224, and 226. In embodiments, the mobile device app may include a device registry, virtual personal assistant (VPA) registry, user account management, interface management, store, support, handler (e.g., including workflow, virtual payment account API, voice service software development kit), and the like. In embodiments, hearable device update images and app store catalog data may be sent over-the-air from storage, e.g., stored in cloud storage. Preliminary management tools for data logging may be facilitated via web services and managed via a metrics provider. The mobile device app may provide customer support. In this configuration, the primary interface for the voice services is the mobile app, whereas the hearable device handles wake word detection as well as audio and data communication with the mobile app.

### Example Use Cases

In an example use case, in a push-to-talk or triggered listening mode, a user interfaces with the hearable device and initiates a listening mode. In the listening mode, the hearable device captures voice input and wakes a communication device, such as a wireless platform. Thereafter, the captured audio is transmitted wirelessly to a device connected via a suitable communication mechanism such as a personal area network, e.g., to a smartphone running a mobile device app. The mobile device app may include functionality of a WWE to distinguish between one of two more wake words for predetermined voice services, as outlined in FIG. 1. After determining a particular wake word is present, the mobile app initiates a connection with the voice service, which may be running on the device having the mobile device app or may be running in the cloud.

Another example use case for the platform is to enable always-listening voice assistant interactions for the user. In this use case the hearable device is always listening for a configured voice assistant wake word and then initiates the appropriate interactions. In an example, a hearing device is always listening for the occurrence of one of the following wake words: “wake word 1” or “wake word 2”. The three most common use cases are: (1) the hearing device is quiet, but listening for wake words, (2) the hearing device is playing an advanced audio distribution profile (A2DP) audio stream from the smartphone, and (3) the hearing device is engaged in a phone call.

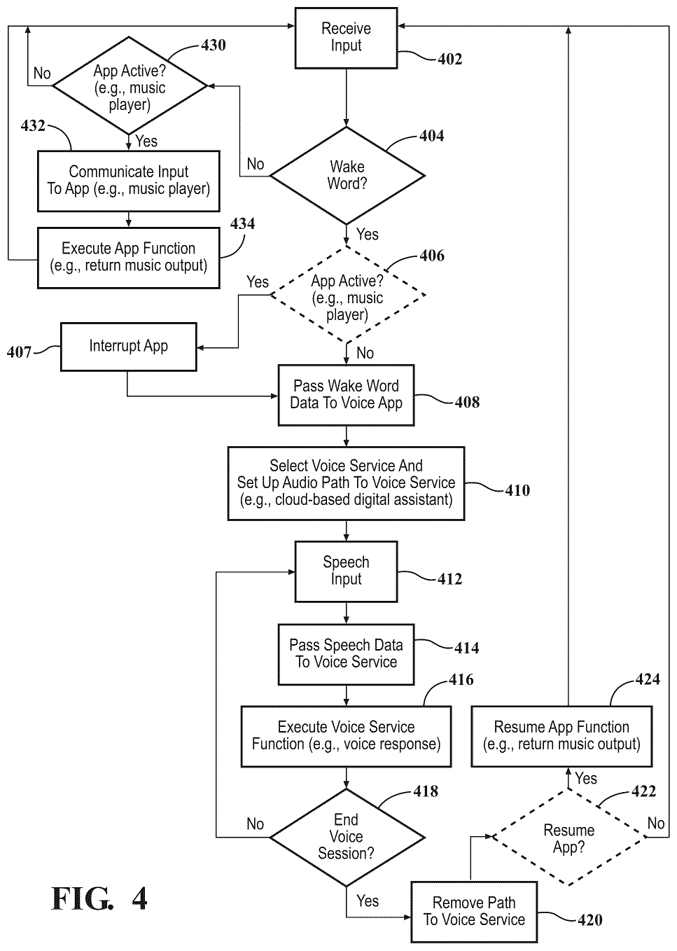

An example of handling user interactions in each of these scenarios is illustrated in FIG. 4. In FIG. 4, the dashed elements correspond to the scenario where another app (e.g., music player) is active. In the case where a phone call is being handled, optionally the hearable device may transition out of always listening mode and ignore any wake words that may be spoken during the conversation (e.g., the wake word engine is deactivated at the beginning of a call and reactivated when the call ends).

Use cases 1 (no other active application) and 2 (active application) are shown in FIG. 4. In use cases 1 and 2, the system optionally buffers speech audio to enable natural speech without waiting for a “go” response from the voice assistant, except as required by a voice assistant.

In use case 1, a “basic voice activation” is implemented as shown. Initially the hearable device is in always listening mode to receive input 402 and examines detected audio from the user to determine if a wake word has been spoken 404. If not, and no other hearing device application is active, the hearable device continues to listen for a wake word. If a wake word is spoken, it is detected and (if no other application is active), this is communicated as an indication of wake word detection and to pass the wake word the voice app 408 on a connected device (e.g., mobile device 218 of FIG. 2). This permits selection (e.g., by the mobile app) of the appropriate voice service and its activation. The activation may include setting up a path between the hearable device and the voice service 410.

Thereafter, speech input 412 from the hearable device (e.g., voice commands for the voice service) may be passed to the voice service 414 (e.g., via the mobile app, such as in the form of an audio file that is transmitted to the voice service, as concerted to a text file and transmitted to the voice service, and the like) and responses or other functions of the voice service passed back or executed 416, as illustrated. In some examples, audio processing may be applied. For example, audio processing may include adding contextual information such as to provide the ability to understand the audio utterance/command and transfer it to the voice service with some contextual understanding. In another example, concatenation of pre-programmed audio files may be performed, such as prepending a trigger or wake word to the user utterance or buffering or storing of the user utterance for streaming to a voice cloud when the streaming connection is established. If the voice session is ended 418, e.g., as determined by the mobile app or the voice service, the path between the hearable device and the voice service is removed 420. Thereafter, the hearable device reenters the always listening mode to receive input 402.

The data path of the audio or data derived from or based on audio that is transmitted in the flow of FIG. 4 may be implemented via the example hardware described herein. To recap a non-limiting example, communication between the wake word engine and the communication mechanism on board the hearable device may be accomplished via a wired connection between the wake word engine hardware (e.g., chip) and a wireless platform (e.g., a wireless platform) running the hearable device (e.g., earbud). Communication between the hearable device and the mobile app may be over a wireless channel, (e.g., wireless communication between the earbud and the smartphone or another mobile device). The mobile app may use the voice service API to communicate directly with a virtual assistant in the cloud, e.g., a voice service accessed via an internet connection managed by the mobile device.

Use case 2, a “voice activation while playing music” scenario, is also shown in FIG. 4. If a wake word is detected and an application is active 406, the audio application may be paused or interrupted 407 and thereafter resumed at 422 and 424 following an interaction session with a voice service. As stated, a user actively speaking (e.g., on a phone call) may present a scenario where the wake word engine is powered down or declines to communicate wake words, even if detected, for the duration of the event (e.g., voice call). If a wake word is not detected at 404, and it is determined that an application is active 430, the input audio may be communicated to the application 432 and execute an application function 434 if appropriate (e.g., for voice control of the audio application, if possible). Otherwise, if no application is active at 430 the hearable device returns to always listening mode to receive input 402.

Additionally, to protect the user's privacy, the system may be also able to require a keyword in addition to the wake word. The keyword can be determined by the user in advance. For example, the user has to say the keyword, so that when they're accessing the specific service or special information such as privacy information including credit card information, it's an extra layer of security.

### Voice Utilities

In embodiments, “voice utilities” or voice apps may be included as frequently utilized voice functions native to a device or device ecosystem. A voice utility is a frequent function the user may invoke using their voice. The voice utility may be invoked with different wake words or one wake word associated with the voice utility. Each voice service or app is a digital program, for example hosted in the cloud, a user can interact with by talking to a microphone and receiving a response via a speaker.

The voice services or voice apps may come native to the device, such as a front end device in the form of a hearable device or other hearable, similar to a smartphone where some apps are native to the device—e.g., an email client, a map app, a telephone, a contact directory, a flashlight button, and the like, may come, at least in part, on the device from the manufacturer.

In embodiments, audio hardware devices may offer some fundamental voice services similar to the smartphone manufacturers. For example a voice input of “text” is handled equivalently to text messaging using a soft keyboard, that is the voice input results in an automated function of initiating a text messaging or other communication program and listening for a contact input, e.g., “tell mom ‘x’” voiced after “text” results in a voice snip containing the audio file or text conversion of “x” being sent to the contact “mom” using a text messaging or other messaging program.

Non-limiting examples of voice utilities are provided as follows. Each revolves around the concept that the user will likely have a set of commonly used voice functions that should be natively supported by a device or combination of devices, e.g., a hearable device connected to another device, such as a smartphone, automobile, smart home device, and the like, or a cloud service. This can be facilitated by, for example, including programmed actions or responses that result after a voice utility command is received.

The voice utilities may interact with one another (e.g., exchange data) or with another service. Certain interactions between utilities or other services may be pre-programmed, e.g., the order of automated interaction may be defined according to a safety or other rule (e.g., such as with car control utilities in the examples below). By way of specific example, a weather voice utility may accept input of “[wake word] what is the weather” and respond, after identifying an associated weather service application resident on a connected mobile phone, by querying the weather application, e.g., for relevant weather data (e.g., daily forecast) and responding to the user with audio output.

The program code for the voice utilities may be located in a variety of locations, such as on a connected smartphone, included as part of a cloud voice service, a hearable device, or a combination thereof. In each case, the user's voice input is associated with voice utility activation, and a predetermined voice utility action or set of actions is/are performed, where one or more (a set) of voice utilities are included in the device natively without requiring user download.

### Non-Limiting Example Voice Utilities:

| | |
|---|---|
| Voice Snip | Equivalent to a text message but the user sends a receives small |
| | voice clips. The voice snip may be delivered as an audio file or in a |
| | text format. A voice file may be received back by the user or a |
| | text file and this text may or may not be converted to speech. |
| Map Data | The Map Data utility allows various other utilities to specify a |
| | variety of locations including cities, addresses, and landmarks |
| Weather | The Weather utility allows the user to make enquiries about past, |
| | present, and future weather conditions in various locations and get |
| | back the requested information |
| Date and Time | The Date and Time utility allows the user to make enquiries |
| | relating to dates and times in various locations and get back the |
| | requested information |
| Small Talk | The Small Talk utility engages in small talk with the user - e.g., a |
| | chatbot functionality |
| Wikipedia | The Wikipedia utility allows the user to ask questions and get back |
| | relevant information from Wikipedia |
| Map | The Map utility allows the user to request maps of various places |
| | and get back those maps, e.g., for display on a connected or |
| | associated device |
| Music Player Control | The Music Player utility allows the user to control a music player |
| | application with commands such as ‘next song’, ‘repeat’, ‘stop’, |
| | ‘rewind by 30 seconds’, etc. |
| Knowledge | Knowledge command answers factual questions |
| Sports | This utility enables the Sports Queries |
| Music Search | The Music Search utility allows the user to ask music-related |
| | questions and get back the answers |
| Phone | The Phone utility allows the user to make phone calls, either by |
| | number or using information in the user's contact list |
| Navigation | The Navigation utility allows the user to request help with |
| | navigation to specified places |
| Arithmetic | The Arithmetic utility allows the user to pose arithmetic questions |
| | and get back the answers |
| Stock Market | The Stock Market utility allows the user to ask questions about the |
| | stock market, including recent information on prices, trading |
| | volumes, etc. |
| Navigation Control | The Navigation Control utility allows the user to control the |
| | navigation feature of their device, which could be a GPS, or an |
| | integrated car navigation system, or any other device that provides |
| | this sort of service |
| Calendar | The Calendar utility allows the user to manage a personal calendar |
| Dictionary | The Dictionary utility allows the user to ask questions about the |
| | meanings and spellings of words and get back the answers |
| Music Charts and Genre | The Music Charts utility allows the user to ask music charts- |
| | related questions, optionally specifying country and genre, and |
| | play or view tracks from the charts |
| Alarm | The Alarm utility allows the user to set and modify time-based |
| | alarms |
| Device Control | This utility allows the user to control various features of a device |
| | such as turning WIFI on or off |
| Currency Converter | The Currency Converter utility allows the user to ask questions |
| | about conversions between different currencies and get back the |
| | answers |
| Flight Status | The Flight Status utility allows the user to make queries about the |
| | schedule and current status of commercial airline flights |
| Timer | The Timer utility allows the user to set and modify a timer |
| Local Search | The Local Search utility allows the user to make queries about |
| | local businesses such as restaurants in various locations |
| Unit Converter | The Unit Converter utility allows the user to ask questions about |
| | conversions between different units of measure and get back the |
| | answers |
| Nutrition | The Nutrition utility allows the user to ask questions about |
| | nutritional facts about various foods and get back the answers |
| Hotel | The Hotel utility allows the user to find information about hotels, |
| | including current availability |
| SMS | The SMS utility allows the user to send text messages to contacts |
| | or phone numbers |
| Equation Solver | This utility solves simple equations such as “if x plus three equals |
| | zero what is x” |
| Email | The Email utility allows the user to send e-mail |
| Tip Calculator | The Tip Calculator utility assists the user in figuring gratuity for |
| | meals and services |
| Flight Booking | The Flight Booking utility allows the user to find information |
| | about commercial airline flights that can be booked |
| Games Menu | The Games Menu utility presents the user with a list of games that |
| | can be played verbally |
| Astronomy | The Astronomy utility provides information for astronomical |
| | queries |
| Mortgage Calculator | The Mortgage Calculator utility lets the user ask questions about |
| | mortgages and provides the answers |
| Volume Control | This utility allows the user to control a device's sound volume |
| User Memory | The User Memory utility allows the user to have the system |
| | remember and recall various pieces of user-specific information, |
| | such as the location of the user's car |
| Car Control | The Car Control utility allows the user to control various features |
| | of the car such as adjusting the climate |
| Emergency and Special | The Emergency and Special Phone Numbers utility lets the user |
| Phone Numbers | speak or type certain special or emergency phone numbers, such as |
| | “an ambulance”, “the operator”, and “information” |
| Car Window Control | This utility allows the user to control the windows and moonroof |
| | of the car |
| Car SeatHeater Control | This utility allows the user to control the seat heaters of the car |
| Car Door Control | This utility allows the user to control the doors and trunk hatch of |
| | the car |
| Radio Control | The Radio Control utility lets the user control a radio |
| Car Status Control | This utility allows the user to query the status of parts of the car in |
| | various ways |
| Map Control | This utility allows the user to control the view and zoom of a map |
| Car Driving Control | This utility allows the user to control the automatic driving |
| | assistive features of the car |
| Car Lights Control | This utility allows the user to control the lights on the car |
| Car Seat Control | This utility allows the user to control the seats of the car |
| Car Camera Control | This utility allows the user to view and take pictures from the |
| | cameras on their car |
| Car Mirror Control | This utility allows the user to control the rearview mirrors of the |
| | car |
| Brightness Control | This utility allows the user to control the brightness of the phone's |
| | display, or use the night shift or invert colors features |
| Car Convertible Control | This utility must be selected in addition to the Car Control |
| | Command and operates to control a convertible roof of a car |
| Bluetooth Control | This utility allows the user to control a device's Bluetooth WPAN |
| | connection, by turning it on or off, or asking if it's on |
| Device Location Services | This utility allows the user to turn Location Services on and off on |
| | a device, such as a connected smartphone |
| Home Automation | The Home Automation utility allows users to control devices |
| Commands | and/or groups using voice |
| Countdown | The Countdown utility allows the user to ask for a countdown and |
| | then presents a countdown from ten to zero |
| WIFI Control | This utility allows the user to control or search for internet |
| | connections such as turning WiFi on or off |
| Power Control | This utility allows the user to power off, lock, or restart a phone, as |
| | well as put it in power saving or airplane mode |
| Car Screen Control | This utility allows the user to control the multifunction display on |
| | the dashboard of a car |
| Voice Synthesis Control | This utility allows the user to control the speed and pitch of a |
| | device's voice synthesis |
| Android App Launcher | The Android App Launcher utility allows the user to launch any |
| | app installed on an Android client |
| Age Calculator | The Age Calculator utility was created to answer users' questions |
| | about age, such as how old they are |
| Battery Control | This utility allows the user to check a device's battery status |
| Camera Control | This utility allows the user to take pictures with a device's camera |
| Ringer Control | This utility allows the user to control the ringing behavior of a |
| | phone |
| Flashlight Control | This utility allows the user to control the flashlight on a phone |
| Cellular Data Control | This utility allows the user to control the data usage on a phone |
| User Contacts | The User Contacts utility allows the client to synchronize a contact |
| | list |
| IOS App Launcher | The IOS App Launcher utility allows the user to launch any app |
| | installed on an iOS client |
| Hotline Phone Numbers | The ‘Hotline Numbers’ utility lets the user speak or type certain |
| | hotline phone numbers, such as “crisis center” |
| AutoRotate Control | This utility allows the user to turn auto-rotate on and off on a |
| | phone |
| Chinese Zodiac | The Chinese Zodiac utility provides information for Chinese |
| | zodiac signs |
| Roaming Control | This utility allows the user to turn roaming on and off on a phone |
| User Feedback | The User Feedback utility is for use by clients that give their users |
| | the option of giving feedback |
| Drink Recipes | Find out what drinks can be made given a set of ingredients or |
| | what ingredients are in a particular drink |
| Area Code | This utility allows the user to ask queries about US telephone area |
| | codes |
| Robot Control | The Robot Control utility allows users to control robots using their |
| | voice |
| Olympics | This utility answers queries for historical Olympics data including |
| | basic attributes, medal standings and event medal winners |
| Geometry | This utility answers queries like: what is the area of a circle with |
| | radius 10? What is the volume of a cube with side length 5? |
| Periodic Table | The Periodic Table utility answers questions about the periodic |
| | elements and the groups they belong to |
| Account Balance | Check and account balance |
| Lighting Control | Turn on or off a light, dim a light, set a lighting timer |
| Appliance Control | Turn on or off an appliance or change to a particular setting - |
| | oven, microwave, toaster, blender, TV, other audio device, etc. |
| Thermostat control | Set the temperature or a program on a thermostat |

### Command Handling

In addition to interacting with a voice service, e.g., a cloud voice service, a wake word plus command combination may invoke other systems or services. In other words, a wake word followed by a command routes the command to any system (not only a voice service). By way of example, the wake word may open an app on a smartphone, with the command indicating that the app open a particular page or pre-load particular information. This may be combined with the voice utilities listed above, e.g., a wake word plus a command such as “tell me the forecast” may automatically invoke a program that queries a weather app, retrieves forecast data from the weather app, and responds to the user with audio output. In some cases, visual output may be utilized, e.g., displaying weather data on a user's smart watch in addition to or in lieu of audio output via the hearable device that accepted the voice input.

### Embodiments

An example method includes receiving audio data corresponding to a wake word spoken by a user; distinguishing, with a processor using the audio data, between a plurality of predetermined wake words, each predetermined wake word corresponding to one voice service of a plurality of predetermined voice services, the plurality of predetermined wake words including a first predetermined wake word corresponding to the wake word spoken by the user; selecting a first voice service of the plurality of voice services based on distinguishing between the plurality of predetermined wake words; and initiating a communication session with the first voice service of the plurality of predetermined voice services.

Certain further aspects of the example method are described following, any one or more of which may be present in certain embodiments. The audio data is received after a user activates the hearable device into a triggered listening mode. The hearable device is a wireless stereo device. Distinguishing between the plurality of predetermined wake words includes identifying which of the predetermined wake words corresponds to the wake word spoken by the user. The method further including receiving, from the hearable device, a second audio data corresponding to a second wake word spoken by a user; distinguishing between the plurality of predetermined wake words using the second audio data, the plurality of predetermined wake words including a second predetermined wake word corresponding to the second wake word; selecting a second voice service of the plurality of voice services based on distinguishing between the plurality of predetermined wake words; and initiating a communication session with the second voice service of the plurality of predetermined voice services.

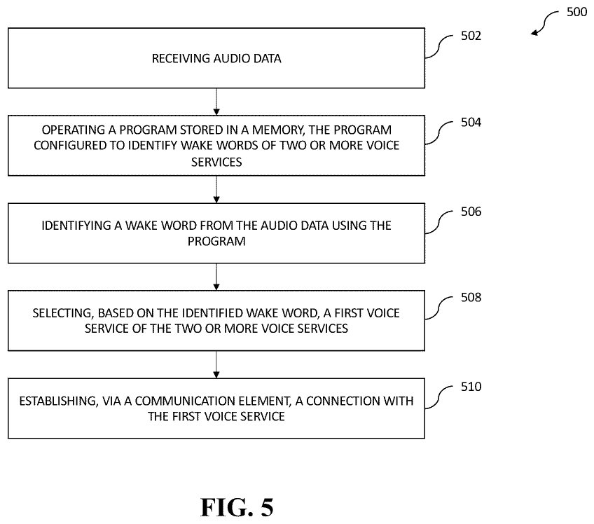

Referring to FIG. 5, an example method 500 includes receiving 502 audio data; operating a program stored in a memory, the program configured to identify 504 wake words of two or more voice services; identifying 506 a wake word from the audio data using the program; selecting 508, based on the identified wake word, a first voice service of the two or more voice services; and establishing 510, via a communication element, a connection with the first voice service.

Certain further aspects of the example method 500 are described following, any one or more of which may be present in certain embodiments. The program is configured to identify wake words using a neural network model trained to identify multiple wake words in parallel. The memory is disposed in a true wireless device. The audio data is substantially continuous audio input. Further comprising processing the received audio data to concatenate audio including a pre-determined audio trigger word. Further comprising processing the received audio data to buffer the received audio data for streaming a user utterance included in the audio data to a voice service. Further comprising processing the received audio data to form pre-programmed audio files comprising a wake word and a user utterance. The user utterance is a command. Further comprising storing the audio data and thereafter transmitting the stored audio data to a voice service across a network. Further comprising communicating a result of the identifying to a remote device after the program identifies the wake word. The result comprises data indicating the voice service to which subsequent audio data is to be provided. The voice service is selected from a predetermined set of voice services. The program is trained to identify wake words of the predetermined set of voice services. The predetermined set of voice services is operable to be updated by a request from the remote device. The method further including receiving a second audio data; identifying a second wake word from the second audio data; and selecting a second voice service of the two or more voice services.

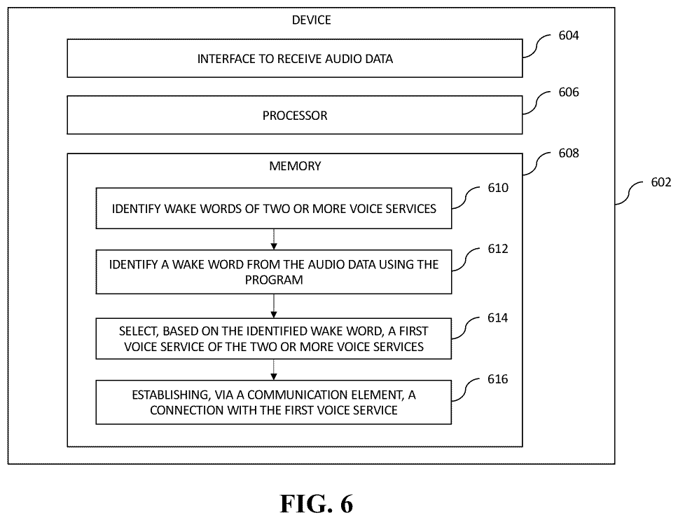

Referring to FIG. 6, an example device 602 includes an interface 604 to receive audio data; a processor 606 operably coupled to a memory 608 with a stored program, the stored program configured to: identify 610 wake words of two or more voice services; identify 612 a wake word from the audio data using the program; select 614, based on the identified wake word, a first voice service of the two or more voice services; and establishing 616, via a communication element, a connection with the first voice service.

Certain further aspects of the example device 602 are described following, any one or more of which may be present in certain embodiments. The stored program is configured to identify wake words using a neural network model trained to identify multiple wake words in parallel. The memory is disposed in a true wireless device. The audio data is substantially continuous audio input. Further comprising processing the received audio data to concatenate audio including a pre-determined audio trigger word. Further comprising processing the received audio data to buffer the received audio data for streaming a user utterance included in the audio data to a voice service. Further comprising processing the received audio data to form pre-programmed audio files comprising a wake word and a user utterance. The user utterance is a command. Further comprising storing the audio data and thereafter transmitting the stored audio data to a voice service across a network. Further comprising communicating a result of the identifying to a remote device after the program identifies the wake word. The result comprises data indicating the voice service to which subsequent audio data is to be provided. The voice service is selected from a predetermined set of voice services. The stored program is trained to identify wake words of the predetermined set of voice services. The predetermined set of voice services is operable to be updated by a request from the remote device. The stored program further configured to receive a second audio data; identify a second wake word from the second audio data; and select a second voice service of the two or more voice services.

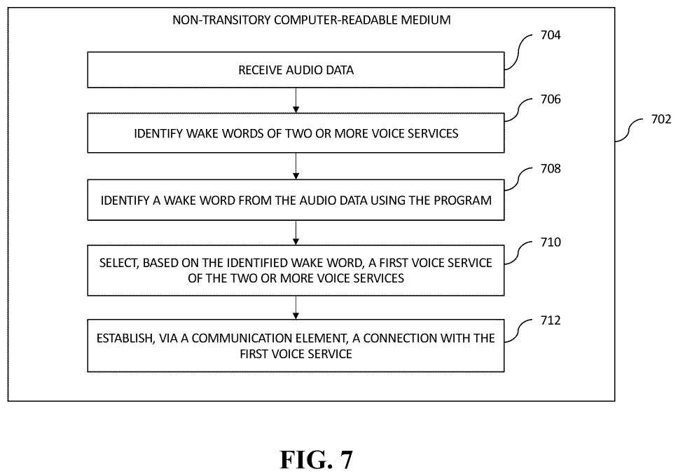

Referring to FIG. 7, an example non-transitory computer-readable medium 702 having stored thereon instructions, that when performed by a processor of a computing device, cause the computing device to at least: receive 704 audio data; identify 706 wake words of two or more voice services; identify 708 a wake word from the audio data; select 710, based on the identified wake word, a first voice service of the two or more voice services; and establish 712, via a communication element, a connection with the first voice service.

Certain further aspects of the example non-transitory computer-readable medium 702 are described following, any one or more of which may be present in certain embodiments. The instructions are configured to identify wake words using a neural network model trained to identify multiple wake words in parallel. The instructions are stored on a memory disposed in a true wireless device. The audio data is substantially continuous audio input. Further comprising processing the received audio data to concatenate audio including a pre-determined audio trigger word. Further comprising processing the received audio data to buffer the received audio data for streaming a user utterance included in the audio data to a voice service. Further comprising processing the received audio data to form pre-programmed audio files comprising a wake word and a user utterance. The user utterance is a command. Further comprising storing the audio data and thereafter transmitting the stored audio data to a voice service across a network. Further comprising communicating a result of the identifying to a remote device after the program identifies the wake word. The result including data indicating the voice service to which subsequent audio data is to be provided. The voice service is selected from a predetermined set of voice services. The instructions stored in a program is trained to identify wake words of the predetermined set of voice services. The predetermined set of voice services is operable to be updated by a request from the remote device. Further including receiving a second audio data; identifying a second wake word from the second audio data; and selecting a second voice service of the two or more voice services.

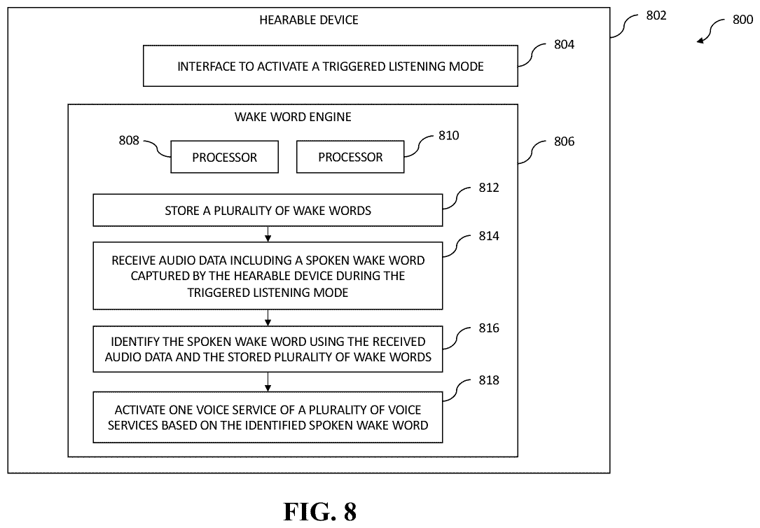

Referring to FIG. 8, an example audio system 800 includes a hearable device 802 wearable by a user including an interface 804 to activate a triggered listening mode; a wake word engine 806 comprising a processor 808 and a memory 810, the wake word engine being configured to: store 812 a plurality of wake words, receive 814 audio data including a spoken wake word captured by the hearable device during the triggered listening mode, identify 816 the spoken wake word using the received audio data and the stored plurality of wake words, and activate 818 one voice service of a plurality of voice services based on the identified spoken wake word.

Certain further aspects of the example audio system 800 are described following, any one or more of which may be present in certain embodiments. The wake word engine is incorporated into the hearable device. The wake word engine is incorporated on a local device structured to communicate with the hearable device, wherein the captured audio data is transmitted to the local device without the hearable device processing the captured audio data to detect a wake word. The memory is configured to store the plurality of wake words including a neural network model trained to detect multiple wake words in parallel. The wake word engine identifies the spoken wake word by distinguishing between the plurality of stored wake words using the neural network model. The hearable device comprises a wireless communication device, and wherein the wake word engine identifies the spoken wake word prior to waking the wireless communication device. The interface includes a button.

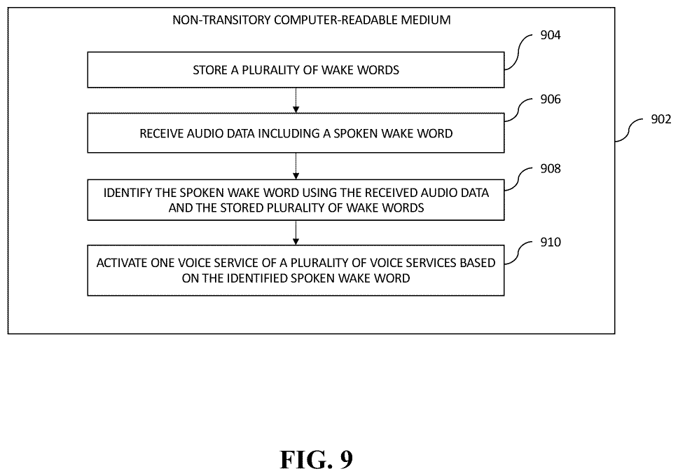

Referring to FIG. 9, an example non-transitory computer-readable medium 902 having stored thereon instructions, that when performed by a processor of a computing device, cause the computing device to at least: store 904 a plurality of wake words; receive 906 audio data including a spoken wake word; identify 908 the spoken wake word using the received audio data and the stored plurality of wake words; and activate 910 one voice service of a plurality of voice services based on the identified spoken wake word.

Certain further aspects of the example non-transitory computer-readable medium 902 are described following, any one or more of which may be present in certain embodiments. Receiving the audio data includes communicating with a wireless communication interface of an external device. Storing the plurality of wake words includes storing a neural network model trained to detect multiple wake words in parallel. Identifying the spoken wake word includes by distinguishing between the plurality of stored wake words using the neural network model.

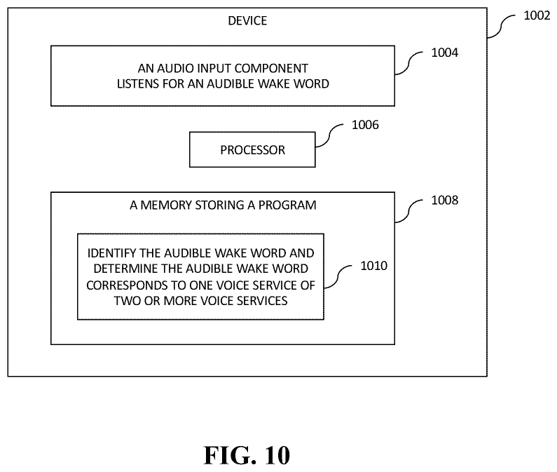

Referring to FIG. 10, an example device 1002 includes an audio input component 1004, wherein the audio input component listens for an audible wake word; a processor 1006; and a memory 1008 storing a program which, when executed by the processor, is configured to identify 1010 the audible wake word and determine the audible wake word corresponds to one voice service of two or more voice services.

Certain further aspects of the example device 1002 are described following, any one or more of which may be present in certain embodiments. The audio input component listens for the audible wake word in an always-listening mode. The audio input component listens for the audible wake word in a triggered-listening mode. The program includes a neural network configured to identify two or more wake words in parallel. The device is at least one of a wireless stereo device, earbud, and hearable device. The device is at least one of a vehicle component, a smartphone, a smart speaker, a tablet, a personal computer, and an audio system. The device is an earbud and the memory is disposed within the earbud. The device is a headphone and the memory is disposed within the headphone. The program is configured to identify wake words of two or more voice services using substantially continuous audio data received via a microphone. The processor identifies the audible wake word without communicating with another device to identify the audible wake word. Further including an output element configured to communicate a result to a remote device after the program identifies a wake word. The result comprises data indicating a voice service to which subsequent audio data is to be provided. The voice service is selected from a predetermined set of voice services. The program is trained to identify wake words of the predetermined set of voice services. The predetermined set of voice services is operable to be updated by a request from the remote device. The subsequent audio data is received via a microphone. The program is trained to identify wake words of the two or more voice services. Additional voice services are added via an update to the program. The audio input component is a microphone and wherein the device comprises a wake word engine including the memory and a processor configured to execute the program stored on the memory.

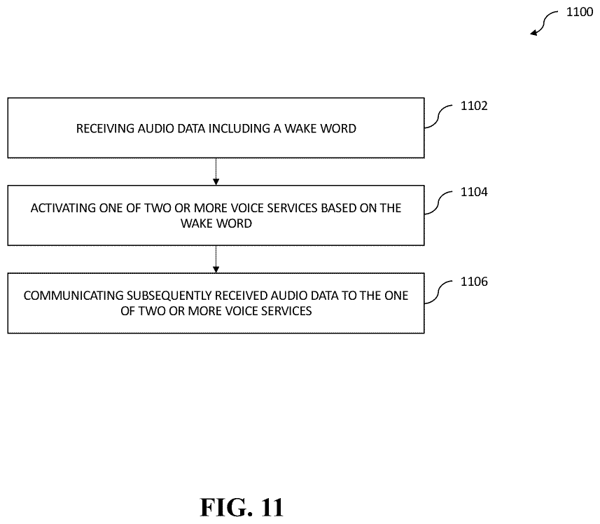

Referring to FIG. 11, an example method 1100 includes receiving 1102 audio data including a wake word; activating 1104 one of two or more voice services based on the wake word; communicating 1106 subsequently received audio data to the one of two or more voice services.

Certain further aspects of the example method 1100 are described following, any one or more of which may be present in certain embodiments. Further comprising identifying, from subsequently received audio data, a request for payment. Further comprising accessing a payment method based on the request for payment. The payment method is available to more than one of the two or more voice services. Further comprising communicating data of the payment method to the one of two or more voice services that has been activated. Further comprising storing profile data derived from one or more of the audio data and subsequently received audio data. The profile data has a restricted access. The restricted access is on a per user basis. The restricted access selectively permits access to the profile data. The restricted access permits selective access to the profile data. The restricted access is in response to a user permission. The restricted access is derived from the profile data. The restricted access is derived from a voice print included in the profile data. The restricted access is derived from a detected keyword included in the audio data which is a predetermined keyword selected by a user.

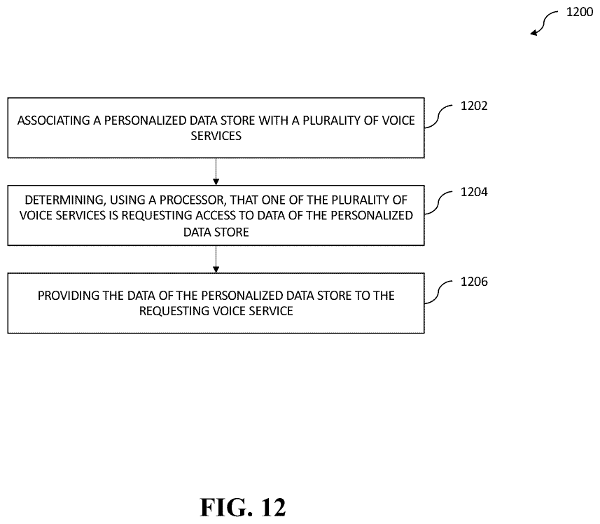

Referring to FIG. 12, an example method 1200 includes associating 1202 a personalized data store with a plurality of voice services; determining 1204, using a processor, that one of the plurality of voice services is requesting access to data of the personalized data store, the data including profiling data derived in part from audio data; and providing 1206 the data of the personalized data store to the requesting voice service.

Certain further aspects of the example method 1200 are described following, any one or more of which may be present in certain embodiments. The profiling data is associated with a user having one or more accounts with the plurality of voice services. The profiling data is at least one of identified by device ID, a predetermined keyword, a voice pin, and a voice print. The personalized data store comprises payment data associated with a user having one or more accounts with the plurality of voice services. The data of the personalized data store allows the requesting voice service to be customized. The customization uses all or part of the personalized data store. The customization uses an analysis of all or part of the personalized data store. The data of the personalized data store provided to the requesting voice service is a subset of the data. The data of the personalized data store is obfuscated or provided in summary form. The data of the personalized data store includes an indication of a user preference. The one of the plurality of voice services requests access indirectly via an intermediary. The intermediary is a payment processor.

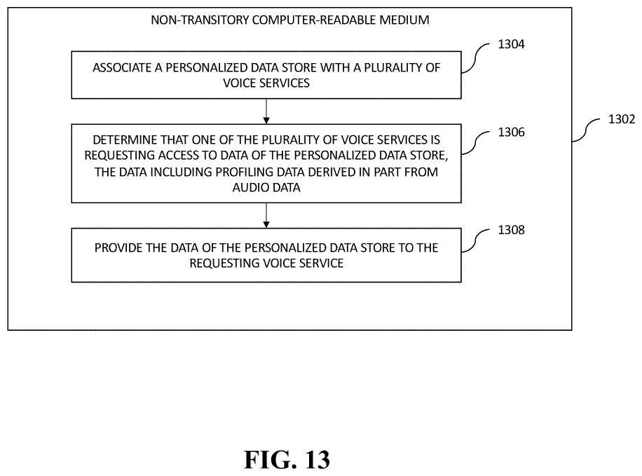

Referring to FIG. 13, an example non-transitory computer-readable medium 1302 having stored thereon instructions, that when performed by a processor of a computing device, cause the computing device to at least: associate 1304 a personalized data store with a plurality of voice services; determine 1306 that one of the plurality of voice services is requesting access to data of the personalized data store, the data including profiling data derived in part from audio data; and provide 1308 the data of the personalized data store to the requesting voice service.

Certain further aspects of the example non-transitory computer-readable medium 1302 are described following, any one or more of which may be present in certain embodiments. The profiling data is associated with a user having one or more accounts with the plurality of voice services. The profiling data is at least one of identified by device ID, a predetermined keyword, a voice pin, and a voice print.

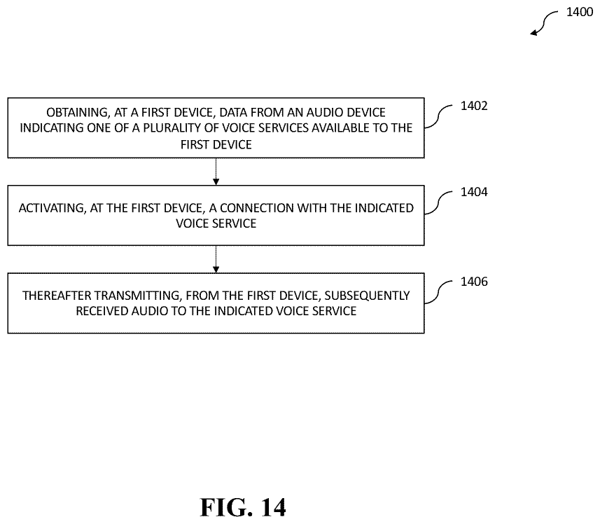

Referring to FIG. 14, an example method 1400 includes obtaining 1402, at a first device, data from an audio device indicating one of a plurality of voice services available to the first device; activating 1404, at the first device, a connection with the indicated voice service; and thereafter transmitting 1406, from the first device, subsequently received audio to the indicated voice service.

Certain further aspects of the example method 1400 are described following, any one or more of which may be present in certain embodiments. The first device is one of a mobile phone, a tablet, a smart speaker, a television, a PC, an automobile, or a hearable device with wireless internet connectivity. The voice service resides on a remote device. The audio device is operatively coupled to the first device. The audio device is integrated into the first device. The audio device is a wireless stereo device. The wireless stereo device comprises a microphone and a memory storing a program configured to identify two or more wake words, each wake word corresponding to one of the plurality of voice services available to the first device. Further including obtaining, at a second device associated with the first device, data from the audio device indicating one of a plurality of voice services available to the second device; activating, at the second device, a connection with the indicated voice service; and thereafter transmitting, from the second device, subsequently received audio to the voice service.

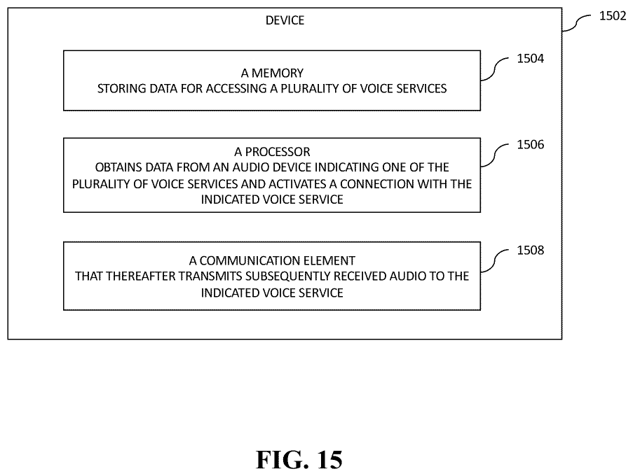

Referring to FIG. 15, and example device 1502 includes a memory 1504 storing data for accessing a plurality of voice services; a processor 1504 that obtains data from an audio device indicating one of the plurality of voice services and activates a connection with the indicated voice service; and a communication element 1506 that thereafter transmits subsequently received audio to the indicated voice service.

Certain further aspects of the example device 1502 are described following, any one or more of which may be present in certain embodiments. The device is one of a mobile phone, a tablet, a smart speaker, a television, a PC, an automobile, or a hearable device with wireless internet connectivity. The voice service resides on a remote device. The audio device is a wireless stereo device. The wireless stereo device comprises a microphone and a memory storing a program configured to identify two or more wake words each wake word corresponding to one of the plurality of voice services available to the device.

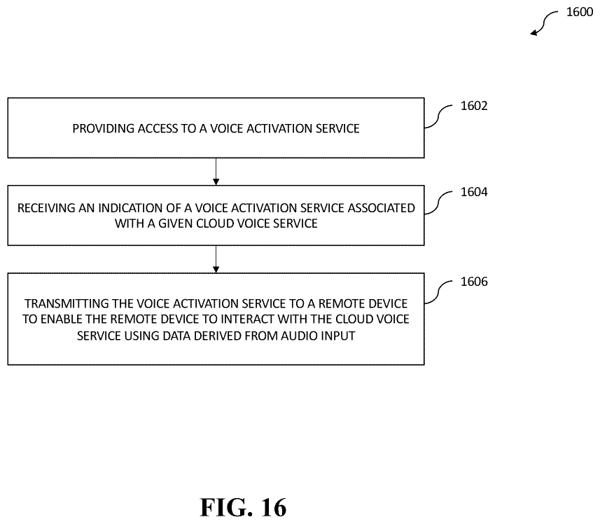

Referring to FIG. 16, an example method 1600 includes providing 1602 access to a voice activation service; receiving 1604 an indication of a voice activation service associated with a given cloud voice service; and transmitting 1606 the voice activation service to a remote device to enable the remote device to interact with the cloud voice service using data derived from audio input.

Certain further aspects of the example method 1600 are described following, any one or more of which may be present in certain embodiments. The remote device generated the indication. The indication is a user selection. The indication is a command to download a partner application. The voice activation service includes a wake word model for identifying a wake word. The wake word model is supplied to the remote device. The remote device is a wireless stereo device. The wake word model replaces an existing wake word model resident on the remote device.

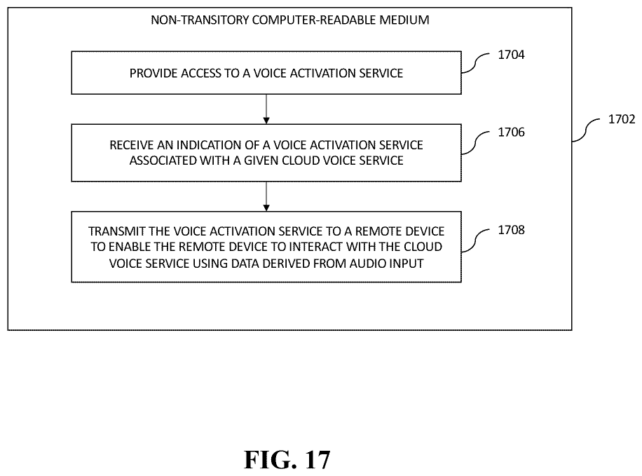

Referring to FIG. 17, an example non-transitory computer-readable medium 1702 having stored thereon instructions, that when performed by a processor of a computing device, cause the computing device to at least: provide 1704 access to a voice activation service; receive 1706 an indication of a voice activation service associated with a given cloud voice service; and transmit 1708 the voice activation service to a remote device to enable the remote device to interact with the cloud voice service using data derived from audio input.

Certain further aspects of the example non-transitory computer-readable medium 1702 are described following, any one or more of which may be present in certain embodiments. The voice activation service includes a wake word model for identifying a wake word. The wake word model is supplied to the remote device. The remote device is a wireless stereo device. The wake word model replaces an existing wake word model resident on the remote device.

### Processing Infrastructure

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4^{th} Generation (4G) networks (e.g. Long Term Evolution (LTE)) or 5^{th} Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1-105. (canceled)

106. A method, comprising:
receiving, by a processor of a first device, audio data;
processing, by the processor, a user request from the audio data;
determining, by the processor, a type of voice service that is configured to process at least a portion of the user request from a plurality of available voice services;
selecting, by the processor, a first voice service from the plurality of voice services based upon the determined type of voice service, wherein the first voice service is configured to perform at least one action in response to the user request; and
initializing, by the processor, an instance of the first voice service to process the user request, wherein the instance of the first voice service is performed on the first device, a cloud-based device operably coupled to the first device, or a combination of the first device and the cloud-based device.

107. The method of claim 106, wherein the user request comprises a wake word associated with at least one of the plurality of voice services.

108. The method of claim 106, wherein the type of voice service comprises one or more of entertainment, sports, chat, product ordering, weather, map/navigation, news, phone, calendar, dictionary, flight status, timer, or calculator.

109. The method of claim 106, wherein initializing the instance of the first voice service comprises:
determining, by the processor, a location of the first voice service;
transmitting, by the processor, at least a portion of the audio data to the first voice service;
receiving, by the processor, a response to the user request from the first voice service; and
outputting, by the processor, at least a portion of the response to the user.

110. The method of claim 106, further comprising:
receiving, by the processor, a request for personalized user information from the first voice service;
identifying, by the processor, the requested personalized user information from a data store accessible by the processor; and
transmitting, by the processor, at least a portion of the identified personalized user information to the first voice service.

111. The method of claim 110, wherein the request for personalized user information comprises a security feature indicating user permission to transmit the at least a portion of the identified personalized user information to the first voice service, wherein the security feature comprises a biometrically identified voice keyword or voice identifier.

112. The method of claim 106, further comprising exchanging, by the processor, information between the first voice service and a second voice service of the plurality of voice services, wherein the second voice service is configured to process at least a portion of the audio data.

113. The method of claim 112, wherein the exchanged information comprises personalized information about the user that the first voice service has collected and stored on a first data store accessible by the processor.

114. The method of claim 106, wherein the processor is configured to process the audio data using a neural network model.

115. The method of claim 106, wherein the audio data comprises substantially continuous audio input.

116. A system, comprising:
a non-transitory computer-readable medium configured to store at least a set of instructions;
an audio input device configured to receive input audio data;
an audio output device configured to output audio data; and
a processor operably coupled to the non-transitory computer-readable medium, the audio input device, and the audio output device, the processor configured to execute at least a portion of the set of instructions to:
receive audio data from the audio input device,
process a user request from the audio data,
determine a type of voice service that is configured to process at least a portion of the user request from a plurality of available voice services,
select a first voice service from the plurality of voice services based upon the determined type of voice service, wherein the first voice service is configured to perform at least one action in response to the user request, and
initialize an instance of a first voice service to process the user request, wherein the instance of the first voice service is performed on the first device, a cloud-based device operably coupled to the first device, or a combination of the first device and the cloud-based device.

117. The system of claim 116, wherein the user request comprises a wake word associated with at least one of the plurality of voice services.

118. The system of claim 116, wherein the type of voice service comprises one or more of entertainment, sports, chat, product ordering, weather, map/navigation, news, phone, calendar, dictionary, flight status, timer, or calculator.

119. The system of claim 116, wherein the processor is configured to initialize the instance of the first voice service by being further configured to:
determine a location of the first voice service;
transmit at least a portion of the audio data to the first voice service;
receive a response to the user request from the first voice service; and
output, via the audio output device, at least a portion of the response to the user.

120. The system of claim 116, wherein executing at least a portion of the set of instructions further causes the processor to:
receive a request for personalized user information from the first voice service;
identify the requested personalized user information from a data store accessible by the processor; and
transmit at least a portion of the identified personalized user information to the first voice service.

121. The system of claim 120, wherein the request for personalized user information comprises a security feature indicating user permission to transmit the at least a portion of the identified personalized user information to the first voice service, wherein the security feature comprises a biometrically identified voice keyword or voice identifier.

122. The system of claim 116, wherein executing at least a portion of the set of instructions further causes the processor to exchange information between the first voice service and a second voice service of the plurality of voice services, wherein the second voice service is configured to process at least a portion of the audio data.

123. The system of claim 122, wherein the exchanged information comprises personalized information about the user that the first voice service has collected and stored on a first data store accessible by the processor.

124. The system of claim 116, wherein the processor is configured to process the audio data using a neural network model.

125. The system of claim 116, wherein the audio data comprises substantially continuous audio input.
